(19) United States
(12) Patent Application Publication
(10) Pub. No.: US 2006/0044684 A1
(43) Pub. Date: Mar. 2, 2006

(54) Recording disk cartridge

(75) Inventor: Kengo Oishi, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/188,769

(22) Filed: Jul. 26, 2005

(30) Foreign Application Priority Data
Aug. 26, 2004 (JP) 2004-246173

(51) Int. Cl. G11B 23/03

(52) U.S. Cl. 360/133

(57) ABSTRACT

A recording disk cartridge accommodating a plurality of flexible recording media is provided having ease of construction and of changing the number of the media, and an excellent dustproof ability. A plurality of magnetic disc media 41 exemplifying the recording disc media are housed in a cartridge case 2. The cartridge case 2 comprises a lower plate 10 constructing a lower wall parallel to the magnetic disc media 41, inner plates 20 which are stacked and fixed on the lower plate 10 to partition a plurality of magnetic disc media 41, and an upper plate 30 that is stacked and fixed on the inner plates 20 to construct an upper wall of the cartridge case 20. A dust removal liner 49 is provided on a lower rotor 51 provided on the inner face side of the lower plate 10, the inner plates 20, and an upper rotor 52 provided on the inner face side of the upper plate 30.

### BACKGROUND OF THE INVENTION

1. Field of the Invention

The present invention relates to a recording disk cartridge comprising a plurality of flexible recording disk media.

2. Description of the Related Art

Conventionally, as a recording disk medium a flexible recording disk medium is known where a magnetic layer is formed on both faces of a disc-form support body consisting of a flexible material such as a polyester sheet. Although the magnetic disk medium has a merit of speedily accessing data in comparison with a magnetic tape, on the other hand, it has a demerit of a memory capacity being small because a recording area thereof is small.

In order to solve the demerit of the flexible magnetic disk medium, it is conventionally disclosed a magnetic disk cartridge for housing a plurality of magnetic disk media in one cartridge case (for example, see JP 2004-22011A).

In this connection, because a flexible magnetic disk medium is low in rigidity thereof, there is a problem that the medium tends to vibrate in a vertical direction for a recording face when rotated. Therefore, in an invention of JP 2004-22011A each magnetic disk medium is made a configuration of being pinched by shutters. Thus by arranging plate members of high rigidity such as the shutters in a vicinity of the magnetic disk medium, the recording face can be stabilized because the medium becomes along the plate members, accompanied with a rotation of the medium.

However, because a magnetic disk cartridge of JP 2004-22011A is configured of movable shutters arranged by four for one magnetic disk medium, there is a problem that the cartridge is complicated in a structure thereof and is difficult to keep a parallelism to the medium. In addition, because the magnetic disk cartridge is mass produced goods, it is preferable to be excellent in assembling ability and productivity. It is also preferable that the cartridge have an excellent dustproof ability to prevent an occurrence of data error in recording and reproducing data. Furthermore, the magnetic disk cartridge is preferable to be high in a degree of freedom in a design change so as to easily set a plurality of kinds thereof where number of magnetic disk media is made three, five, and the like.

From such a background is strongly requested a recording disk cartridge having a simple structure, excellent in assembling ability and productivity, easy in changing a number of recording disk media, and also having an excellent dustproof ability.

### SUMMARY OF THE INVENTION

A recording disk cartridge of the present invention is one where a plurality of flexible recording disk media integrally and rotatably housed within a cartridge case, the case comprising:
a lower plate for configuring a lower wall parallel to the plurality of recording disk media;
at least one inner plate that is stacked and fixed on the lower plate, and partitions the plurality of recording disk media; and
an upper plate that is stacked and fixed on the inner plate, and configures an upper wall of the cartridge case,
a lower rotor rotatably provided on the inner side of the lower plate; and
an upper rotor rotatably provided on the inner side of the upper plate,
wherein a dust removal liner is provided on each face of the inner plate, opposite to the recording disc media, and the liner is provided on each face of the lower rotor and the upper rotor, opposite to the recording disc media.

In accordance with such the configuration, in the recording disk cartridge of the present invention the cartridge case is configured in a form of stacking up the lower plate, the inner plate, and the upper plate. Therefore, a pair of the inner plate and the recording disk medium is made one unit, all inner plates can be made a same part, and therefore, the recording disk cartridge is excellent in productivity. And because the recording disk medium in an assembling process can also be carried by making a lower plate and an inner plate as a substitute of a tray, the recording disk cartridge is excellent also in assembling ability without damaging and staining the medium. In addition, in a case that it is intended to make a specification of changing a number of recording disk media, it is easy to change the specification because it suffices to mainly change a number of inner plates. Furthermore, because an inner plate of a partition plate is fixed as part of the cartridge case, the recording disk cartridge is easy to realize accuracy such as a parallelism to the recording disk media and can heighten a rotational stability especially at a high speed such as 2000 to 8000 rpm.

Further, since the dust removal liner is provided on each face of the inner plates opposite to the recording disc medium, and each face of the lower rotor and the upper rotor opposite to the recording disc medium, the effect of removing dust adhering to the surfaces of the recording media is high, the surfaces are always kept clean, and thus a recording disc cartridge having an excellent dustproof ability is obtained. Consequently, an occurrence of date error in recording or reproducing the recording media can be avoided, and reliability increased.

In addition, by forming the liner provided on the lower rotor thicker than that provided on the inner plate, dustproof effect can be enhanced for the lowermost recording disc medium, especially for the lower face of the lowermost recording disc medium. This keeps clean the surface of the lowermost recording disc medium (especially the lower face of the recording disc medium) which is easily exposed to dust entering from outside of the cartridge case.

Further, dust removal effect for the lowermost recording medium can also be enhanced by providing the lower rotor with a liner that is the same type as, and similar to or larger in thickness and unit weight than the liner provided on the inner plate.

Each of the liners on the lower rotor, the inner plate, and the upper rotor can be formed from a combination of woven and unwoven cloths, or a woven or an unwoven cloth.

### BRIEF DESCRIPTION OF THE DRAWINGS

FIG. 1 is an exploded perspective view of a magnetic disk cartridge related to an embodiment of the present invention.

FIG. 2A is an external perspective view of a magnetic disk cartridge with a shutter closed related to an embodiment of the present invention; FIG. 2B is an external perspective view with the shutter opened related to the magnetic disk cartridge.

FIG. 3 is a perspective view showing an inner face of an upper plate.

FIG. 4 is a section view taken along a line IV-IV in FIG. 2B of the magnetic disk cartridge loaded on a magnetic disk drive.

FIG. 5 is a partially enlarged drawing of FIG. 4.

FIG. 6 is an exploded perspective view showing a stack structure of magnetic disk media.

### DESCRIPTION OF THE PREFERRED EMBODIMENTS

Here will be described an embodiment of the present invention in detail, referring to drawings as needed. In the embodiment will be described a case of adopting a magnetic disk medium as an example of a recording disk medium.

Meanwhile, in a description below, with respect to up/down directions, making it a standard a typical use state of the magnetic disk cartridge, vertical directions for faces of magnetic disk media are called the up/down directions for convenience.

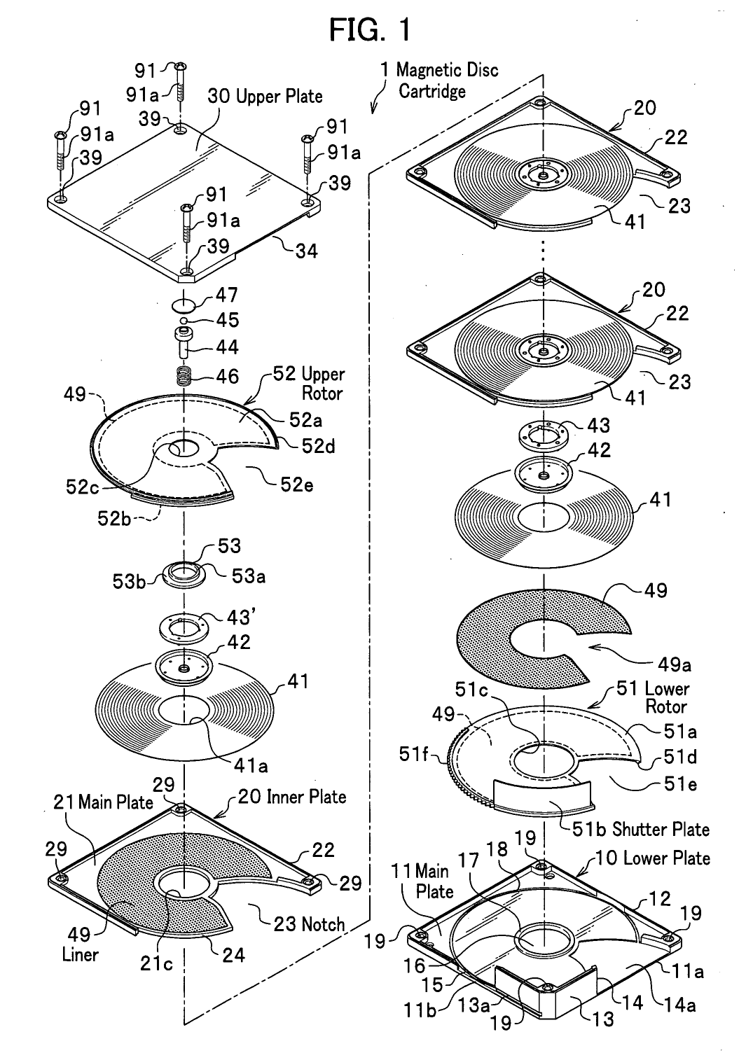

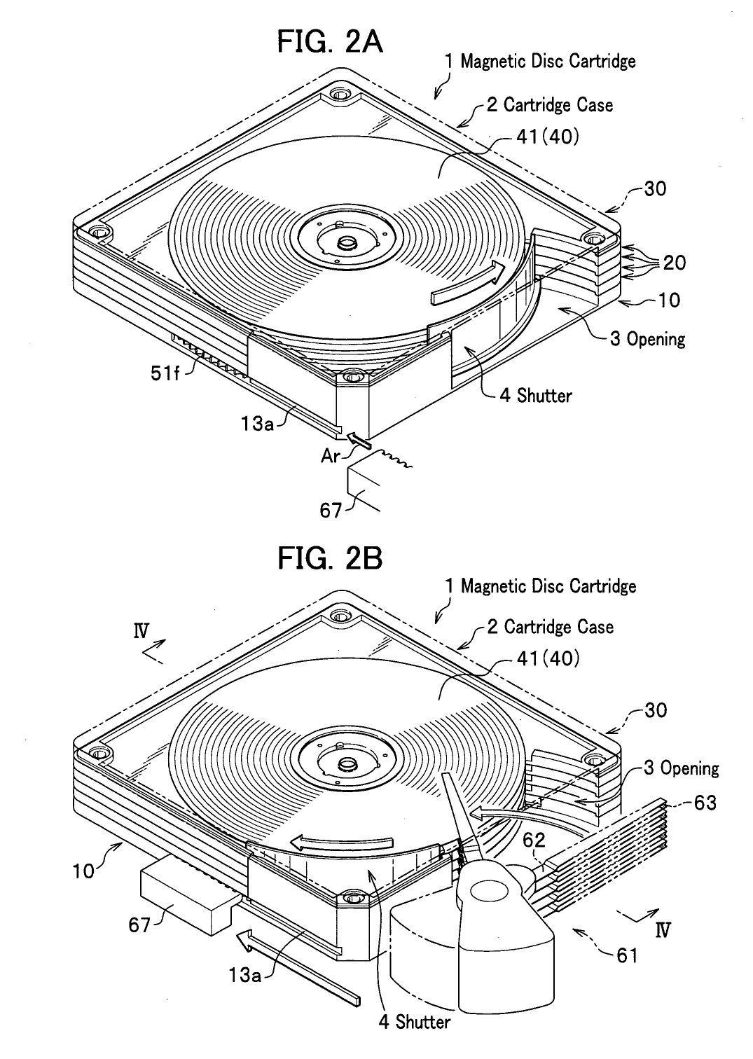

As shown in FIG. 1, in a magnetic disk cartridge 1 of an example of a recording disk cartridge are stacked a lower plate 10 for configuring a lower wall thereof a plurality of, for example, four inner plates 20, and an upper plate 30 for configuring an upper wall thereof in this order; these are fastened and fixed with four screws 91; and thereby a cartridge case 2 (see FIG. 2A) is configured. Between the lower plate 10 and the lowermost inner plate 20, between any adjacent two of the four inner plates 20, and between the uppermost inner plate 20 and the upper plate 30 is arranged a magnetic disk medium 41, respectively. Each magnetic disk medium 41 is a disc form having an opening 41a at center thereof, and a center core 42 made of metal is affixed at rim of the opening 41a. It is designed that any adjacent two center cores 42 are engaged by spacers 43, 43′, and that five magnetic disk media 41 (the magnetic disk media 41 stacked and integrated are assumed to be a disk stack 40) are integrally rotated.

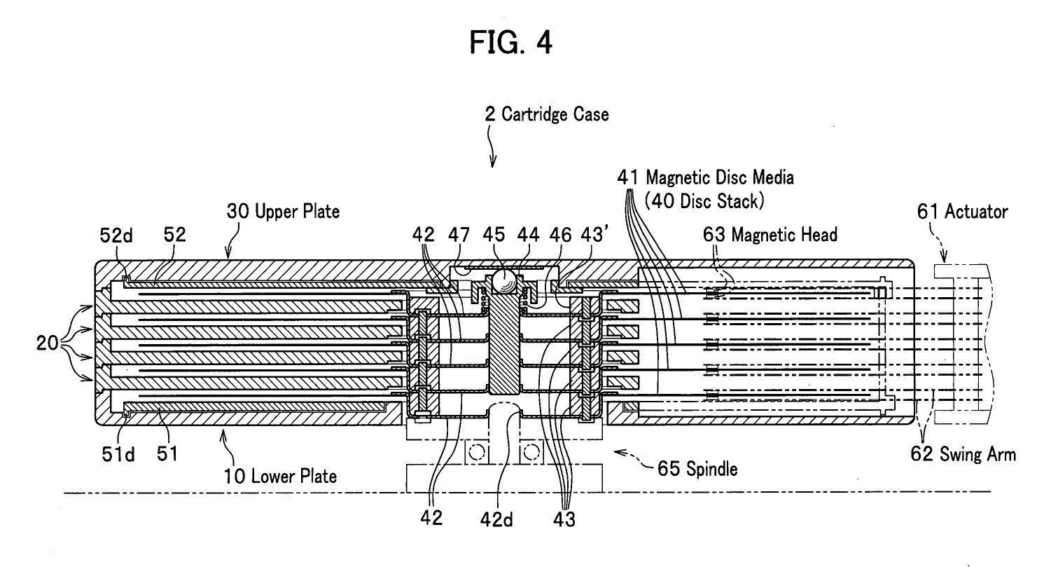

In each of the inner plates 20 is formed a rib 22 for abutting with upper/lower plates at a peripheral rim of a flat main plate 21. Part of a right near side of each of the inner plates 20 in FIG. 1 forms a notch 23 so that magnetic heads 63 (see FIG. 4) can easily move onto the magnetic disk media 41. At the portion of the notch 23 is not formed the rib 22, and therefore, when the inner plates 20 are stacked up, an opening 3 is formed on a side face of the cartridge case 2 as shown in FIG. 2A.

The opening 3 is opened/closed by a shutter 4 that coaxially rotates with the disk stack 40. As shown in FIG. 1, the shutter 4 is configured by combining a lower rotor 51 and an upper rotor 52.

Next will be described each member in more detail.

The lower plate 10 is designed at a peripheral rim of a main plate 11 of a substantially square to mainly form a side wall 13 and a rib 12 for abutting with a lower face of the rib 22 of the lowermost inner plate 20. The side wall 13 is vertically provided in a predetermined range, for example, around one third range of one edge, from one corner of the main plate 11 (near side corner in FIG. 1), and is formed approximately in height of the inner plates 20 stacked.

A sector portion toward a center of the main plate 11 from one edge 11a (one edge of right near side in FIG. 1) continuing into the side wall 13 of the main plate 11 is designed to form a depression 14a lowered by one step, not to form the rib 12 at the peripheral rim of the main plate 11, and to become an opening 14. Thus it becomes easy for the magnetic heads 63 to proceed into the cartridge case 2.

An approximately central one third range of the other edge 11b (one edge of left near side in FIG. 1) continuing into the side wall 13 of the main plate 11 is designed not to form the rib 12 but to become an opening 15 so that a gear 51f of the lower rotor 51 described later can be exposed. In addition, outside the side wall 13 of the other edge 11b is formed a groove 13a along a periphery of the lower plate 10, continuing into the opening 15. The groove 13a is designed to be a passage where a shutter open gear 67 (see FIG. 2A) of a magnetic disk drive proceeds in a direction shown in an arrow Ar of FIG. 2A and enters in the opening 15 in order to engage in the gear 51f.

The rib 12 is formed so as to protrude upward across all periphery except the side wall 13 and the openings 14,15 out of a peripheral rim of the main plate 11. At center of the main plate 11 is formed a circular opening 16 for exposing the center core 42 provided inside the lowermost magnetic disk medium 41. At upper rim of the opening 16, across all periphery thereof is formed a rib 17 outside which a central opening 51c formed at center of the lower rotor 51 fits. The rib 17 rotationally freely supports the lower rotor 51.

In addition, on an upper face (inner face) of the main plate 11 is formed a circular lower rotor support groove 18 at a position corresponding to peripheral rim of the lower rotor 51. The lower rotor support groove 18 rotationally freely supports the lower rotor 51 coaxially with the magnetic disk media 41 by engaging in a rib 51d (see FIG. 4) formed downward at a peripheral rim of the lower rotor 51.

In addition, at four corners of the main plate 11 are formed screw holes 19 where female threads are formed, respectively, with penetrating through the up/down directions.

The main plate 21 of each of the inner plates 20 is substantially a square, and a portion corresponding to one of four corners of the square is designed to be an arc (arc portion 24) one size larger than the magnetic disk medium 41. At one edge (right near side in FIG. 1) continuing into the arc portion 24 is formed the notch 23 into a sector. The rib 22 protrudes the up/down directions and is formed across all periphery except the arc portion 24 and the notch 23 out of periphery rim of the main plate 21. At center of the main plate 21 is formed a central opening 21c for enabling the upper center core 42 to be exposed and to be coupled with the lower center core 42.

In addition, at three corners of the main plate 21, with penetrating through the three corners in the up/down directions, are formed holes 29 through which screw shaft portions 91a of the screws 91 are inserted, respectively.

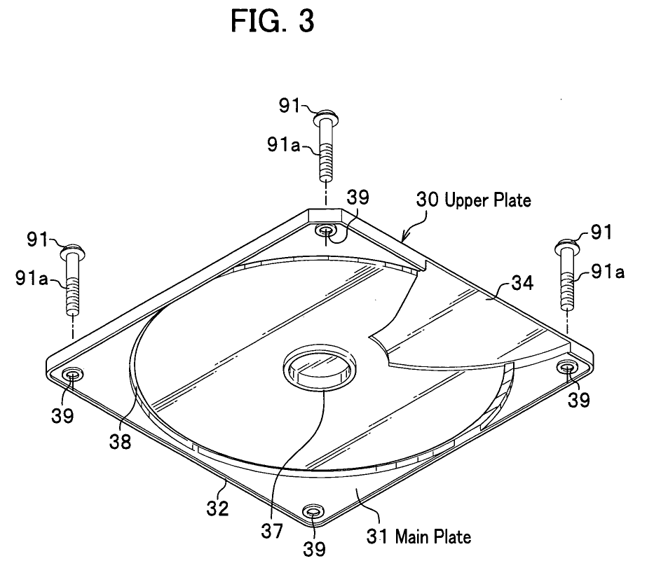

The upper plate 30 is formed substantially symmetric to the lower plate 10. As shown in FIG. 3, in the upper plate 30, on a substantially square main plate 31 are formed a depression 34 corresponding to the depression 14a, a rib 37 corresponding to the rib 17, and an upper rotor support groove 38 corresponding to the lower rotor support groove 18. Meanwhile, at center of the main plate 31 are not formed an opening and a side wall corresponding to the side wall 13.

In addition, at a peripheral rim of the main plate 31, across all periphery except the depression 34 is formed a rib 32 protruding downward.

In addition, at four corners of the main plate 31 are respectively formed holes 39 that enables the screw shaft portions 91a of the screws 91 to be penetrated therethrough.

The lower rotor 51 is designed so that: a central opening 51c, a notch 51e, a rib 51d, and the gear 51f are formed on a ring-form lower rotor plate 51a substantially same as the magnetic disk media 41; and a shutter plate 51b is vertically provided at the peripheral rim of the lower rotor plate 61a. The central opening 51c is formed as a circle fitting outside the rib 17, the notch 51e is formed as a sector corresponding to the depression 14a. In addition, the rib 51d is provided downward at a peripheral rim of a lower face of the lower rotor plate 51a, corresponding to the lower rotor support groove 18.

The shutter plate 51b is a blocking member for blocking the opening 3 (see FIG. 2A) and the disk stack 40 and is vertically provided along the peripheral rim of the lower rotor plate 51a with neighboring the notch 51e. The gear 51f is an engaged portion for opening/closing the shutter 4 (see FIG. 2A) from outside of the magnetic disk cartridge 1, and is formed at a peripheral rim of the lower rotor plate 51a within a predetermined range with neighboring the shutter plate 51b.

The upper rotor 52 is designed to be substantially symmetric to the lower rotor 51: the upper rotor 52 comprises an upper rotor plate 52a similar to the lower rotor plate 51a; on the upper rotor plate 52a are formed a central opening 52c fitting outside the rib 37 of the upper plate 30, a notch 52e corresponding to the depression 34, and a rib 52d corresponding to the upper rotor support groove 38. In addition, at a portion adjacent to the notch 52e of a peripheral rim of the upper rotor plate 52a is formed a shutter groove 52b, corresponding to the shutter plate 51b of the lower rotor 51. The lower rotor 51 and the upper rotor 52 are designed to integrally rotate by the shutter groove 52b and upper end rim of the shutter plate 51b engaging.

The upper rotor 52 is rotationally freely supported by the upper plate 30 by the central opening 52c fitting outside the rib 37 of the upper plate 30, and the rib 52d engaging in the upper rotor support groove 38. Meanwhile, the upper rotor 52 is prevented from dropping from the upper plate 30 by a stop member 53. The stop member 53 comprises a cylindrical portion 53a inserted in the rib 37 (see FIG. 3) and a flange 53b formed at one end of the cylindrical portion 53a; the cylindrical portion 53a is inserted in the central opening 52c from a lower side of the upper rotor 52 and is fixed at the rib 37 by ultrasonic welding, adhesion, and the like.

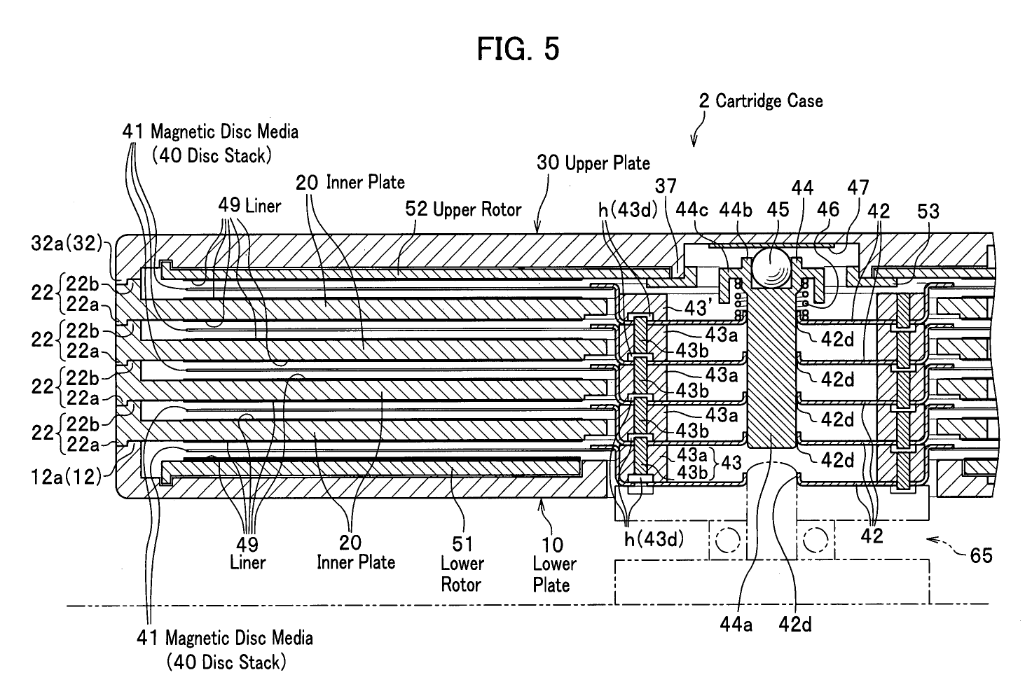

As an enlarged section drawing shown in FIG. 5, an upper face of the lower rotor 51, upper and lower faces of the inner plates 20, and a lower face of the upper rotor 52 are faces opposing the magnetic disk media 41, where liners 49 for removing dust adhering to the surfaces of the magnetic disc media 41 are affixed across portions opposing the media 41, respectively.

The liners 49 consist of, for example, a non-woven cloth such as a polyester fiber and a blended fabric fiber of rayon and polyester. In this embodiment, all liners 49 are formed of an unwoven cloth made of a same type of material. Each liner 49 has a round form matching that of the magnetic disc media 41, and comprises a notch 49a with a sector shape (see FIG. 1) that corresponds to notches 51e, 23, and 52e of the lower rotor 51, the inner plate 20, and the upper rotor 52, respectively. Each liner 49 of the lower rotor 51, the inner plate 20, and the upper rotor 52 may be formed from a combination of woven and unwoven cloths, or a woven cloth.

Such a liner 49 is typically affixed using a ultrasonic welding and adhesion. Welding patterns (welding lines) of the liner 49 by the ultrasonic welding include a grid form, vertical, horizontal, or slant lines of a continuous or wave line, or radial wave lines.

Each liner 49 is formed in a same form, which equalizes the contact resistances between the liners 49 and the media 41. Here, if the liners 49 had different forms, the contact resistances would be different for each magnetic disc medium 41 and greatly affect the reliability in recording to and reproducing from the media. In the present embodiment, on the contrary, the contact resistances are kept at an equal level, so that highly reliable recording or reproducing can be achieved.

Further, in the embodiment, the liner 49 affixed to the lower rotor 51 is formed thicker than the liners 49 affixed to the inner plates 20 and the upper rotor 52. This makes the space below the lower face side of the lowermost magnetic disc medium 41 narrower than the space thereabove. In other words, the lowermost magnetic medium 41 is designed to easily contact the liner 49.

Here, while a common approach for thickly forming the liner 49 is to increase the unit weight of the liner, the side of the liner 49 opposite to magnetic disc medium 41 may be subjected to a raising treatment. The raising by the treatment is preferably performed with respect to a liner 49 having, for example, a roop-formed fiber structure. The treatment may be conducted entirely or partially on the face of the liner 49. The treatment may also be performed partially to a plurality of positions on the face. When the treatment is partially performed, it is preferably provided on a position opposite to the notch 49a over the center of the liner 49, because this position has a more stable flow of entrained air occurring by the rotation of the magnetic disc media 41a compared to the side where the notch 49a is present, and therefore has a higher dust-removal effect.

The liner 49 to which the treatment was partially conducted also has a merit that the contact resistance when the medium 41 rotates becomes smaller and therefore the driving torque of the medium 41 is reduced compared to when the treatment is provided on the entire surface of the liner 49. The cartridge 1 is thus obtained where dust removal functionality is ensured and driving torque is reduced.

The contact between the liner 49 and the medium 41 can also be adjusted with the degree of welding by the ultrasonic welding. That is, a smaller amount of welding portions expands the liner 49, making the liner 49 itself inclined to rise from the affixed face thereof, and consequently the contact between the liner 49 and the medium is increased. On the other hand, a larger amount of welding portions tends to cause a small degree of raising and decreases the contact between the liner 49 and the medium 41.

The liner 49 affixed to the lower rotor 51 only requires to be formed with its thickness and unit weight being approximately equal with or greater than the liners 49 affixed to the inner plate 20 and the upper rotor 52. The unit weight of the unwoven cloth is 20 to 50 g/m2, and preferably 30 to 40 g/m2. A unit weight<20 g/m2 is too thin with a demerit such as being easily broken. A unit weight>50 g/m2, on the other hand, interrupts the rotation of the medium 41.

Next will be described a stack structure of the lower plate 10, the inner plates 20, and the upper plate 30.

In the rib 12 of the lower plate 10, as shown in FIG. 5, an inside thereof is formed higher by one step than an outside thereof, and thereby a male type step portion 12a is formed; each rib 22 of the inner plates 20 forms a female type step portion 22a protruding downward at outermost periphery, and thus a periphery of the male type step portion 12a and an inner perimeter of the female type step portion 22a become able to be fitted. In addition, when the lower plate 10, the inner plates 20, and the upper plate 30 are fastened by the screws 91 (see FIG. 1), an upper face of the male type step portion 12a and a corresponding portion of a lower face of the lowermost inner plate 20 are designed to be contacted. Thus, because the rib 12 of the lower plate 10 and the rib 22 of the inner plate 20 are sealingly abutted and fitted each other, an invasion of dust into the cartridge case 2 from outside is prevented.

Similarly, any adjacent two of the inner plates 20, and the uppermost inner plate 20 and the upper plate 30 are stacked by being sealingly abutted and fitted each other. In other words, on an upper face of each of the inner plates 20 is formed a male type step portion 22b where an inside of the upper face is formed higher by one step; at a rib 32 of the upper plate 30 is formed a female type step portion 32a of which outermost periphery protrudes downward by one step. And the male type step portion 22b of one inner plate 20 and the female type step portion 22a of an upper adjacent inner plate 20 are sealingly abutted and fitted each other; the male type step portion 22b of the uppermost inner plate 20 and the female type step portion 32a of the upper plate 30 are sealingly abutted and fitted, and stacked. Thus any adjacent two of the ribs 12, 22, 32 are sealingly abutted and fitted each other, and dust from outside is prevented from invading into the cartridge case 2. In addition, as soon as the lower plate 10, the inner plates 20, and the upper plate 30 are stacked, the side wall 13 of the cartridge case 2 is configured.

In addition, both of the female type step portion 22a and the male type step portion 22b protrude from the main plate 21 beyond a thickness of the liner 49. Therefore, after affixing the liners 49 on the inner plates 20 and making an assembly, then even if placing it on a work bench, the liners 49 do not contact the work bench, and accordingly, are not contaminated with dust and the like.

Such the configuration of the cartridge case 2 by stacking the inner plates 20 facilitates a change of a number of the magnetic disk media 41; although a height change of the side wall 13 and that of the shutter plate 51b are requested, a number of housing units of the magnetic disk media 41 formed within the cartridge case 2 can be changed only by mainly changing a number of the inner plates 20.

Next will be described the magnetic disk media 41 and a stack structure thereof. The magnetic disk media 41 are ones where magnetic paint is coated on both faces of a resin sheet, for example, such as polyester.

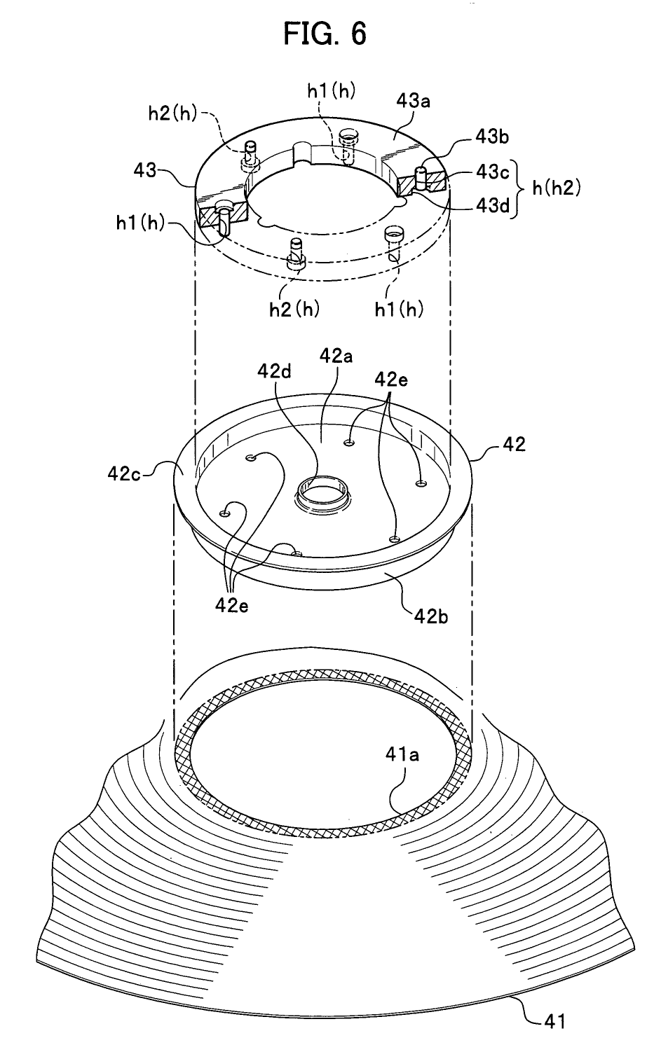

As shown in FIG. 6, each of the center cores 42 is one substantially made a hat form with draw forming a metal plate by press: the center core 42 is mainly configured of a circular bottom plate 42a, a low cylindrical side wall 42b rising from peripheral rim of the bottom plate 42a, and a flange, 42c widening in an outer diameter direction from an upper end of the side wall 42b. At center of the bottom plate 42a is formed a center hole 42d, and at rim of the plate 42a are formed six small holes 42e at a distance of 60 degrees, making the center hole 42d a center thereof.

A spacer 43 is provided between adjacent center cores 42, keeps a distance of each of the center cores 42, stops a rotation between each of the center cores 42, and functions so that the stacked magnetic disk media 41 integrally rotate. The spacer 43 is mainly configured of a main body portion 43a shaped like a ring from a resin and metallic pins 43b pressed into the main body portion 43a. In the main body portion 43a are formed six penetration holes h at positions corresponding to the small holes 42e of the center core 42, wherein each of the penetration holes h consists of a small diameter hole portion 43c, where the pin 43b is pressed, and a large diameter hole portion 43d that is coaxial with and slightly larger in diameter than the small diameter hole portion 43c. The six penetration holes h are designed to be upside down in any two adjacent ones. In other words, penetration holes h2 of both adjacent penetration holes h1, where each the large diameter hole portion 43d is positioned at an upper side thereof, are arranged so that the large diameter hole portion 43d is positioned at a lower side thereof.

Into each of the small diameter portions 43c is pressed each one pin 43b from upper/lower sides thereof, one end of the pin 43b is positioned at a boundary of the large diameter hole portion 43d and the small diameter hole portion 43c, and the other end thereof protrudes outside the small diameter portion 43c. The large diameter hole portion 43d serves a function of a clearance at ends of pins 43b of adjacent spacers 43.

As shown in FIG. 5, such the spacers 43 are provided between adjacent center cores 42, respectively. One pin 43b protruding toward a lower side of each of the spacers 43 enters in a small hole 42e of one center core 42 at the lower side of the spacer 43, and stops a rotation relative to the center core 42 at the lower side. If there is another spacer 43 at a still lower side than the center core 42 at the lower side, a floating-up of the spacer 43 for the center core 42 is prevented by the pin 43b entering the large diameter hole portion 43d in the spacer 43 at the lower side. The other pin 43b protruding toward an upper side of the spacer 43 enters in a small hole 42e of the other center core 42 at the upper side of the spacer 43, and stops a rotation relative to the center core 42 at the upper side. If there is another spacer 43 at a still upper side than the center core 42 at the upper side, the top end of the pin 43b enters in the large diameter hole portion 43d in the spacer 43 at the upper side.

Meanwhile, because at an upper side the uppermost center core 42 has no center core 42 to stop a rotation thereof, at the upper side is arranged a thin top spacer 43′ in thickness where the pin 43b is protruded only downward.

The magnetic disk media 41 thus stacked, namely, the disk stack 40, are stably supported in rotation by a coupling shaft 44, a bearing ball 45, a compression coil spring 46, and a center plate 47.

As shown in FIG. 5, the coupling shaft 44 lessens a central fluctuation between the center cores 42 stacked, holds the bearing ball 45 and the compression coil spring 46, and comprises a shaft portion 44a, a ball holding portion 44b, and a spring holding portion 44c. The shaft portion 44a is a columnar form that can be inserted through the center holes 42d of the center cores 42. At an upper end of the shaft portion 44a the ball holding portion 44b is formed into a cylindrical form with a bottom opening to an upper side thereof. A depth of the ball holding portion 44b is larger than a radius of the bearing ball 45, and therefore, the bearing ball 45 is stably held at the ball holding portion 44b. The spring holding portion 44c consists of a form where a cylindrical form with a bottom is turned down at a side of an outer diameter of the ball holding portion 44b, and the compression coil spring 46 is arranged in a cylindrical space between the shaft portion 44a and the spring holding portion 44c. Meanwhile, although a length of the coupling shaft 44 is arbitrary, in the embodiment it is one reaching the second center core 42 from the lowermost one; the center hole 42d of the lowermost center core 42 is opened so that a spindle 65 of a magnetic disk drive can proceed.

The center plate 47 is a slide member affixed at the center of an inner face of the upper plate 30, that is, on a flat face of an inside of the rib 37. The center plate 47 can be composed of, for example, a material excellent in sliding ability and abrasion resistance such as polyoxymethylene and ultra high molecular weight polyethylene.

Although the bearing ball 45 consists of a sphere made of, for example, steel used for a ball bearing, it may also be composed of a material excellent in sliding ability and abrasion resistance, for example, such as polytetrafluoroethylene and polyoxymethylene. The bearing ball 45 is arranged within the ball holding portion 44b of the coupling shaft 44, abuts with the bottom face of the ball holding portion 44b; and a center of an inner face of the upper plate 30, that is, the center plate 47 by a point contact, and rotationally supports the disk stack 40.

In the compression coil spring 46 one end (upper end) is held by the spring holding portion 44c of the coupling shaft 44; the other end (lower end) abuts with an upper face of the uppermost center core 42, and energizes the stacked center cores 42 to the side of the lower plate 10, that is, to the side of the spindle 65 of the magnetic disk drive. Thus the center cores 42 do not jounce within the cartridge case 2, and the fluctuation of the magnetic disk media 41 is prevented in rotation thereof.

A magnetic disk drive for recoding/reproducing data for the magnetic disk cartridge 1 rotates, as shown in FIG. 4, the disk stack 40 by the spindle 65. The spindle 65 attracts the lowermost center core 42 by magnetic force, enters in the center hole 42d of the center core 42, and thereby matches an axis thereof with that of the disk stack 40. At this time, because the spindle 65 slightly lifts up the center cores 42 with resisting an energizing force of the compression coil spring 46, as shown in FIGS. 4 and 5, each of the magnetic disk media 41 is positioned at center of a space formed between the lower rotor 51 and the lowermost inner plate 20, between upper and lower inner plates 20, and between the uppermost inner plate 20 and the upper rotor 52. The magnetic heads 63 are provided at top ends of swing arms 62. Each of the magnetic heads 63 is arranged on both faces of each of the magnetic disk media 41.

The magnetic disk cartridge 1 thus described can prevent, when not in use, invasion of dust thereto, by rotating the shutter 4 in a counterclockwise direction of the drawing to close the opening 3 as shown in FIG. 2A, and by pressing the disc stack 40 to the opening 16 of the lower plate 10 by means of the compression coil spring 46 provided on the coupling shaft 44 so as to press the lowermost center core 42 to the lower plate 10 (lower rotor 51) to effectively close the opening 16, as shown in FIG. 4. In use thereof as shown in FIG. 2B, when loaded on the magnetic disk drive, the shutter open gear 67 fits in the groove 13a, is guided thereby, engages in the gear 51f, and rotates the shutter 4 in a clockwise direction of the drawing.

Then, the lower rotor 51 and the upper rotor 52 rotate to remove dust on the uppermost and lowermost magnetic disc media 41 by means of each liner 49 affixed to the lower rotor 51 and the upper rotor 52. In this case, dust adhering to the lower face side of the lowermost media 41 is removed in a more preferable manner since the liner 49 affixed to the lower rotor 51 is thicker than other liners 49.

In addition, the disk stack 40 rotates by the spindle 65 rotating. After then, the swing arms 62 rotate by being driven with an actuator 61, and each of the magnetic heads 63 are moved onto each face of the magnetic disk media 41.

When recording data on the magnetic disk media 41 with the magnetic heads 63, the data is recorded thereon by sending a signal to the magnetic heads 63 by a control circuit not shown; when reproducing data from the magnetic disk medium 41, a signal is output by detecting a change of a magnetic field on the medium 41 with the magnetic heads 63a.

At this time, dust on the magnetic disk media 41 is removed by the liners 49 appropriately touching respective media 41.

In this case, since the liner 49 affixed to the lower rotor 51 is thicker than other liners 49, even if dust flowing in through a gap of the opening 16 of the lower plate 10 (including the center hole 42d of the lowermost center core 42) adheres to the lowermost medium 41, the dust can be removed in a preferable manner. In other words, dust which is very likely to adhere to the lower face side of the lowermost media 41 can be effectively removed with the liner 49 affixed to the lower rotor 51.

After the use of the magnetic disk cartridge 1, the magnetic heads 63 are retracted from the cartridge case 2, thereafter ejects the magnetic disk cartridge 1; thereby the gear 51f is driven by the shutter open gear 67, and the shutter 4 closes the opening 3.

Also when the shutter 4 closes, the lower rotor 51 and the upper rotor 52 rotate to remove dust on the lowermost and uppermost magnetic disc media 41.

Thus because the magnetic disk cartridge 1 has a plurality of the magnetic disk media 41, data transfer can be performed at a higher speed by simultaneously accessing data with a plurality of magnetic heads 63.

In addition, because the cartridge case 2 is configured by stacking up the inner plates 20, it is easy to perform a specification change of making a number of magnetic disk media 41 a different one. Then, in assembling the magnetic disk cartridge 1, because the magnetic disk media 41 can be handled with being placed on the inner plates 20 and the lower rotor 51 built in the lower plate 10, an occasion of touching the magnetic disk media 41 can be reduced and a quality of the cartridge 1 can be further stabilized.

In addition, because each of the inner plates 20 is stacked on the lower plate 10 or another inner plate 20 and is fixed, the magnetic disk cartridge 1 can make it higher a parallelism to the magnetic disk media 41, can stabilize a rotation of the media 41, and enable a higher speed rotation of the media 41, furthermore a higher speed of a data transfer.

Further, since the liner 49 is provided on each face of the inner plates 20 which is facing the medium 41 and each face of the lower rotor 51 and the upper rotor 52 which is facing the media 41, the effect of removing dust adhering to the surfaces of the media 41 is high keeping the surfaces always clean, and thus a magnetic disc cartridge 1 with an excellent dust removal ability is provided. Consequently, an occurrence of data error in recording to and reproducing from the media 41 can be avoided, and reliability increased.

Also, because the liner 49 provided on the lower rotor 51 is formed thicker than the liners 49 provided on the inner plates 20 and the upper rotor 52, dust removal effect for the lowermost magnetic disc medium 41 can be enhanced. This yields a merit that the surface (lower face side) of the lowermost medium 41 which is easily exposed to dust entering from outside the cartridge case 2 is kept clean.

Thus, although the embodiment of the present invention is described, the invention is not limited thereto and can be embodied with being changed as needed. For example, although in the embodiment the magnetic disk medium 41 is applied to a recording disk medium, an optical recording medium where data is recorded by light can also be applied thereto.

In addition, although in the embodiment the lower plate 10, the inner plates 20, and the upper plate 30 are fastened and fixed by the screws 91, they can also be integrally fixed by any of adhesion and deposition.

Further, the liner 49 attached to the upper rotor 52 may be formed thicker than the liner 49 provided on the inner plate 20.

What is claimed is:

1. A recording disk cartridge comprising:
a plurality of flexible recording disk media integrally and rotatably housed within a cartridge case, said case comprising:
a lower plate for configuring a lower wall parallel to said plurality of recording disk media;
at least one inner plate that is stacked and fixed on said lower plate, and partitions said plurality of recording disk media; and
an upper plate that is stacked and fixed on said inner plate, and configures an upper wall of said cartridge case,
a lower rotor rotatably provided on the inner side of said lower plate; and
an upper rotor rotatably provided on the inner side of said upper plate,
wherein a dust removal liner is provided on each face of said inner plate, opposite to said recording disc media, and said liner is provided on each face of said lower rotor and said upper rotor, opposite to said recording disc media.

2. A recording disc cartridge according to claim 1, wherein at least said liner provided on said lower rotor, of said lower rotor and said upper rotor, is formed thicker than said liner provided on said inner plate.

3. A recording disc cartridge according to claim 1, wherein at least said liner provided on said lower rotor, of said lower rotor and said upper rotor, is the same type as said liner provided on said inner plate, and is the same as or larger than said liner in thickness and unit weight.

4. A recording disc cartridge according to claim 2, wherein each liner of said lower rotor, said inner plate, and said upper rotor is made of a combination of woven and unwoven cloths, or a woven cloth or an unwoven cloth.

5. A recording disc cartridge according to claim 4, wherein said liner liner is subjected to a raising treatment.

6. A recording disc cartridge according to claim 3, wherein each liner of said lower rotor, said inner plate, and said upper rotor is made of a combination of woven and unwoven cloths, or a woven cloth or an unwoven cloth.

7. A recording disc cartridge according to claim 6, wherein said liner is subjected to a raising treatment.

8. A recording disc cartridge according to claim 5, wherein said raising treatment is partially conducted to a plurality of positions on said liner.

9. A recording disc cartridge according to claim 7, wherein said raising treatment is partially conducted to a plurality of positions on said liner.

10. A recording disk cartridge according to claim 1, wherein said recording disk medium is positioned between any adjacent two of said lower plate, at least one inner plate, and said upper plate.

11. A recording disk cartridge according to claim 10, wherein a center core of each of said recording disk media is engaged to each other and stacked, and a spacer for keeping a stack distance of said recording disk media between adjacent center cores in the stacked recording disk media is provided.

12. A recording disk cartridge according to claim 11, said cartridge further comprising:
a coupling shaft for rotating each of said recording disk media with being connected to said center core;
a ball bearing rotationally freely supporting said coupling shaft inside said recording disk cartridge formed with sequentially combining said lower plate, said at least one inner plate, and said upper plate; and
an energizing mechanism for pressing said center core of the uppermost recording disk medium toward said lower plate.

13. A recording disk cartridge according to claim 1, wherein in said cartridge case an opening for a head's proceeding is formed, and said cartridge case further comprises a shutter for opening and closing said opening, and wherein said head records and/or reproduces data for said recording disk media.

14. A recording disk cartridge according to claim 13, wherein in said inner plate is formed a notch for exposing a recording face of each of said recording disk media, and wherein when said recording disk cartridge is formed with sequentially combining said lower plate, said at least one inner plate, and said upper plate, a position of said notch becomes said opening.

15. A recording disk cartridge according to claim 14, wherein a lower rotor is positioned between said lower plate and an inner plate positioned just above said lower plate, and a shutter plate for opening and closing said opening is provided at part of a peripheral rim of said lower rotor.

16. A recording disk cartridge according to claim 15, wherein an upper rotor is positioned between said upper plate and an uppermost inner plate, a groove for engaging in said shutter plate is provided at a side of said inner plate of a peripheral rim of said upper rotor, and said shutter is formed of said lower rotor and said upper rotor.

17. A recording disk cartridge according to claim 16, wherein a gear is provided on the peripheral rim of said lower rotor.

18. A recording disk cartridge according to claim 17, wherein a groove for guiding a shutter open gear which engages in said gear to operate opening and closing by said shutter plate is provided on a peripheral rim of said lower plate.

19. A recording disk cartridge according to claim 1, wherein said recording disk medium is a magnetic disk medium.

20. A recording disk cartridge according to claim 2, wherein said recording disk medium is an optical disk medium.
